(19) United States
(12) Patent Application Publication
(10) Pub. No.: US 2005/0120031 A1
(43) Pub. Date: Jun. 2, 2005

(54) Structured document encoder, method for encoding structured document and program therefor

(75) Inventor: Nobutake Ishii, Tama-shi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 10/965,786

(22) Filed: Oct. 18, 2004

(30) Foreign Application Priority Data
Nov. 10, 2003 (JP) 2003-379913

(51) Int. Cl. G06F 7/00

(52) U.S. Cl. 707/100

(57) ABSTRACT

A structured document encoder for encoding a structured document which defines a tree structure including nodes includes: a node identifier assigning unit for assigning a node identifier to each of the nodes; a node position information generator for generating node position information for each of the nodes, node position information of an given node from the nodes comprising at least an identifier of the given node, an identifier of a child node of the given node, and an identifier of a next sibling node which has the same parent node as the given node; and a structured document encoded representation generator for generating a structured document encoded representation by combining the node position information and the node content information of all of the nodes.

Priority is claimed on Japanese Patent Application No. 2003-379913, filed Nov. 10, 2003, the content of which is incorporated herein by reference.

### BACKGROUND OF THE INVENTION

1. Field of the Invention

The present invention relates to a structured document encoder for encoding information related to the structured document, and to a method for encoding a structured document and a program therefor.

2. Description of Related Art

In a conventional encoding format used for encoding structured documents, e.g., XML documents, an encoder first parses a structured document to obtain a tree structure defined by a structured document. The encoder then encodes element names, attribute names, attribute values, and the like which represent nodes contained in the tree structure. The encoder separately encodes an element content of each of the nodes, and generates a structured document encoded representation by combining these encoded representations. One exemplary coding technique is Millau, which is discussed in “Millau: an encoding format for efficient representation and exchange of XML over the Web,” Marc Girardot et al., Computer Networks: The International Journal of Computer and Telecommunications Networking, Netherlands, North-Holland Publishing Co., June 2000, Vol. 33, Issue 1-6, p. 747-765.

However, in order to obtain parent-child relationships defined in a tree structure from an encoded representation of a structured document which has been generated using a conventional encoding technique, the document should be parsed again after decoding the encoded representation. Therefore, extracting only information related to a second child node of a root node the encoded representation of the tree structure requires a lot of processing. As a result, in order to extract information related to a particular node in the tree structure of the structured document from the encoded representation, another parsing processing should be carried out, which results in longer processing time.

### SUMMARY OF THE INVENTION

Accordingly, an object of the present invention is to provide a structured document encoder for generating an encoded representation of a structured document which can reduce processing steps for extracting information on a particular node in a tree structure defined in the structured document, and a method for encoding a structured document and a program therefor.

The present invention was conceived to solve the above-mentioned problems, and is directed to a structured document encoder for encoding a structured document which defines a tree structure including nodes having node content information including: a node identifier assigning unit for assigning a node identifier to each of the nodes; a node position information generator for generating node position information for each of the nodes, node position information of an given node from the nodes including at least an identifier of the given node, an identifier of a child node of the given node, and an identifier of a next sibling node which has the same parent node as the given node; and a structured document encoded representation generator for generating a structured document encoded representation by combining the node position information and the node content information of all of the nodes. In a structured document encoded representation generated by the above-mentioned structured document encoder, for each of the nodes in the tree structure defined by the structured document, both an identifier of a child node which facilitates finding the position of each node and an identifier of the next sibling node which has the same parent node as each node are stored. Thus, by using the structured document encoded representation, information related to the content of a particular node in the tree structure defined by the structured document, such as an element content, an element name, an attribute name, and an attribute value, can be easily obtained with fewer processing steps.

Furthermore, according to the present invention, the node position information generated by the node position information generator includes an identifier of a parent node. Therefore, information related to a parent node can be readily obtained from its child node with fewer processing steps.

According to the present invention, each of the nodes is associated with an element name, and at least one of an element content, an attribute name, and an attribute value which are described in the structured document, and the node content information of the given node includes an element name, and at least one of an element content, an attribute name, and an attribute value associated with the given node. Therefore, at least one of an element name, an element content, an attribute name, and an attribute value of the node can be obtained from the structured document.

According to the present invention, each of the nodes is associated with an element name, and at least one of an element content, an attribute name, and an attribute value which are described in the structured document, and the structured document encoder described above further includes: an element name table generator for assigning an element name identifier to an element name associated with each of the nodes and generating an element name table which defines a relationship between the element name and the element name identifier; an element content table generator for assigning an element content identifier to an element content associated with each of the nodes and generating an element content table which defines a relationship between the element content and the element content identifier, the element content being defined in the structured document; an attribute name table generator for assigning an attribute name identifier to an attribute name associated with each of the nodes and generating an attribute name table which defines a relationship between the attribute name and the attribute name identifier; and an attribute value table generator for assigning an attribute value identifier to an attribute value associated with each of the nodes and generating an attribute value table which defines a relationship between the attribute value and the attribute value identifier, wherein the node content information of the given node includes the element name identifier, and at least one of the element content identifier, the attribute name identifier, and the attribute value identifier associated with the given node, and the structured document encoded representation generator generates a structured document encoded representation by combining the element name table, the element content table, the attribute name table, and the attribute value table, in addition to the node position information and the node content information of all of the nodes. Therefore, the content of a node can be decoded into a compact data since information related to the content of the node includes only identifiers, more specifically, not the actual data but identifiers of an element name, the content of the element, an attribute name, and an attribute value.

The present invention is directed to a method for encoding a structured document which defines a tree structure including nodes having node content information, including the steps of: assigning a node identifier to each of the nodes based on the tree structure; generating node position information for each of the nodes, node position information of an given node from the nodes including at least an identifier of the given node, an identifier of a child node of the given node, and an identifier of a next sibling node which has the same parent node as the given node; and generating a structured document encoded representation by combining the node position information and the node content information of all of the nodes.

Furthermore, the present invention is directed to program for encoding a structured document which defines a tree structure comprising nodes having node content information, including processing steps of: assigning a node identifier to each node based on a tree structure, generating node position information for each of the nodes, node position information of an given node from the nodes comprising at least an identifier of the given node, an identifier of a child node of the given node, and an identifier of a next sibling node which has the same parent node as the given node; and generating a structured document encoded representation by combining the node position information and the node content information of all of the nodes.

### BRIEF DESCRIPTION OF THE DRAWINGS

FIG. 1 is a schematic diagram of a structured document encoder according to one embodiment of the present invention;

FIG. 2 illustrates a first example of a structure of a node encoded representation according to one embodiment of the present invention;

FIG. 3 illustrates an example of a tree structure of an XML document obtained by a tree structure parser according to one embodiment of the present invention;

FIG. 4 illustrates an example of a data structure of structured document encoded representation according to one embodiment of the present invention; and

FIG. 5 illustrates a second example of a structure of a node encoded representation according to one embodiment of the present invention.

### DETAILED DESCRIPTION OF THE INVENTION

A structured document encoder according to one embodiment of the present invention will now be described with reference to the attached drawings.

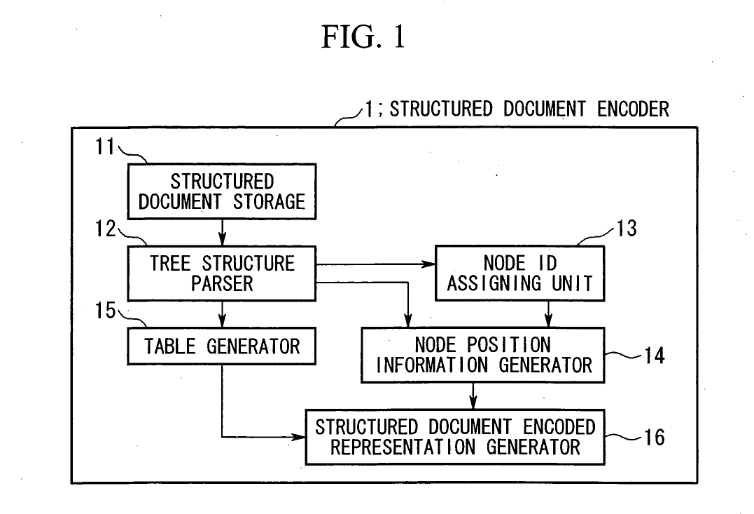

FIG. 1 is a schematic diagram of a structured document encoder according to this embodiment. In this figure, reference numeral 1 denotes a structured document encoder which encodes structured documents. In this structured document encoder, reference numeral 11 denotes a structured document storage which stores encoded representations of structured documents, e.g., XML documents. Reference numeral 12 denotes a tree structure parser which parses a structured document to obtain a tree structure thereof. Reference numeral 13 denotes a node ID assigning unit for assigning a node ID to each of the nodes included in the tree structure obtained by the tree structure parser 12. Reference numeral 14 denotes a node position information generator which generates node position information. The node position information includes a node ID, and optionally IDs of at least one of a parent node, a child node, and a sibling node of each node.

Reference numeral 15 denotes a table generator. The table generator 15 assigns an ID to each of the element name, element content, attribute name, and attribute value of each node, and then generates a table which defines relationships between the assigned IDs and the actual contents of each node, e.g., the element names, element contents, attribute names, and attribute values. Reference numeral 16 denotes a structured document encoded representation generator which generates a structured document encoded representation. A structured document encoded representation defines relationships among the node position information of each of the nodes, the IDs indicating the content of the node, and information related to tables generated by the table generator 15.

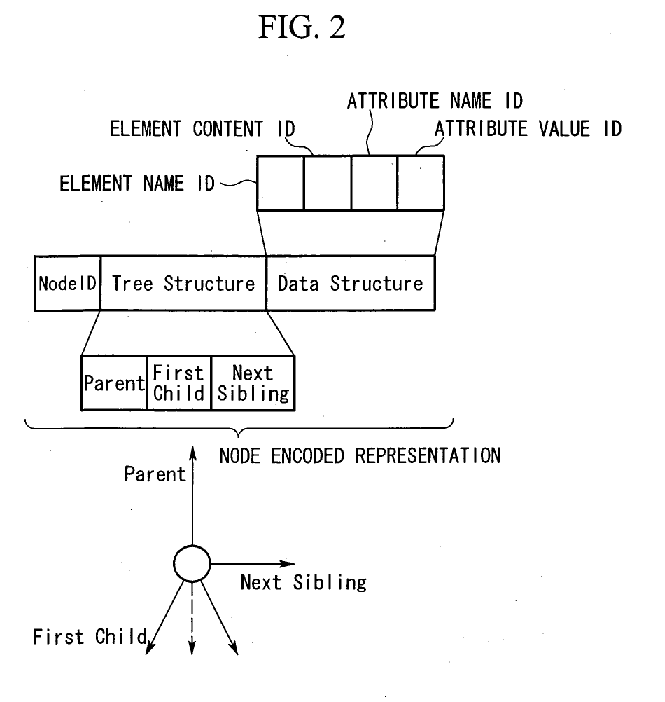

FIG. 2 illustrates a first example of a data structure of a node encoded representation described in a structured document encoded representation. As used herein, “a node encoded representation” refers to a representation of one node of nodes in the structured document encoded representation. As shown in this figure, the node encoded representation includes at least three fields: a field for storing a node ID (the field denoted “Node ID” in the figure), an field for storing node position information (the field denoted “Tree Structure”), and an field for storing IDs indicating the content of the node (the field denoted “Data Structure”). As described above, the node position information includes a parent node ID (“Parent”), a child node ID, and a sibling node ID. In this example, a node ID of a first child node (“First Child”) is used as the child node ID. Furthermore, a node ID of the next sibling node (“Next Sibling”) with respect to the current node is used as the sibling node ID. In a structured document encoded representation, a set of node encoded representations of all of the nodes in the tree structure of the structured document, and actual data, e.g., element names, contents of elements, attribute names, and attribute values. In this example, the “Data Structure” field includes subfields, and the “Element Name ID”, “Content Name ID”, “Attribute Name ID”, and “Attribute Value ID” subfields are used.

Next, processing steps carried out by the structured document encoder 1 will be described in detail.

It is assumed that a representation of an XML document is stored in the structured document storage 11. In response to the document encoder 1 being instructed to encode this XML document, the tree structure parser 12 reads the XML document which is stored in the structured document storage 11, and parses the XML document to obtain the tree structure.

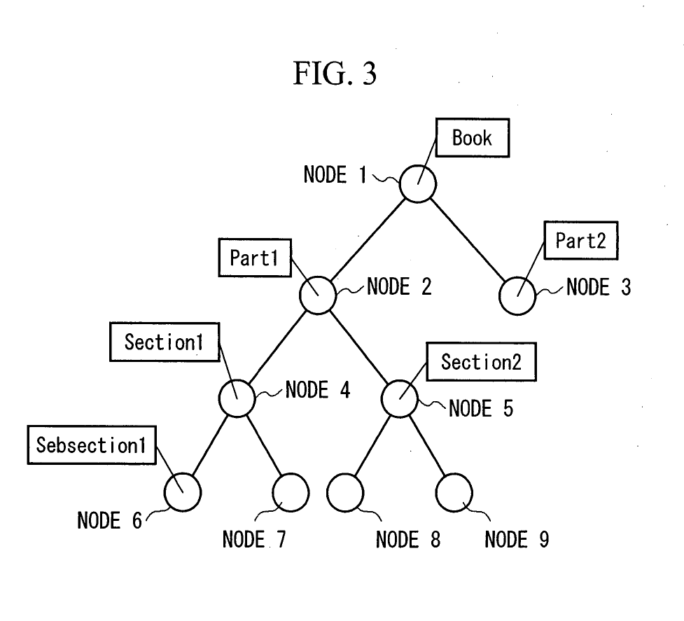

An example of the tree structure of an XML document obtained by the tree structure parser is shown in FIG. 3. Each node in a tree structure of the XML document corresponds to the respective tags described in the XML document. The nodes shown in FIG. 3 correspond to the tags having element names of “Book”, “Part1”, “Part2”, “Section1”, “Section2”, and “Subsection1”.

Once the tree structure parser 12 completes parsing the XML document to obtain the tree structure, the node ID assigning unit 13 assigns a node ID to the respective nodes in the tree structure. The node ID assigning unit 13 assigns node IDs of 01, 02, 03, . . . , and 09 to Nodes 1 to 9 in the tree structure shown in FIG. 3, respectively. Once the node ID assigning unit 13 completes assigning node IDs to all of the nodes, the node position information generator 14 generates node position information related to Node 1. Since Node 1 has no parent node (Parent) and no sibling node (Next Sibling), only a node ID of “02” of the first child node (First Child) of Node 1 is stored in the “First Child” field. The node position information generator 14 also generates node position information related to Node 2. Since the parent node, a sibling node, and a first child node of Node 2 are Node 1, Node 3, and Node 4, repetitively, node IDs of “01”, “04”, and “03” are stored in a node position information field associated with Node 2. In the manner described above, the node position information generator 14 generates node position information for all the nodes in the tree structure.

Once the node position information generator 14 completes generating node position information for all of the nodes in the tree structure which is defined by the XML document, the table generator 15 retrieves an element name, an element content, an attribute name, and an attribute value of the respective nodes from the XML document. The table generator 15 then assigns an element name ID, an element content ID, an attribute name ID, and an attribute value ID to the retrieved element name, element content, attribute name, and attribute value, respectively. If there is more than one node having an identical element name, the table generator 15 assigns the same element content ID to these nodes. This applied to element contents, attribute names, or attribute values. The table generator 15 then generates an element name table, an element content table, an attribute value table, and an attribute name table which describe relationships between assigned IDs and actual data. More specifically, the element name table, the element content table, the attribute value table, and the attribute name table each describe relationships between element name IDs and element names, element content IDs and element contents, attribute name IDs and attribute names, and attribute value IDs and attribute values, respectively.

Next, the structured document encoded representation generator 16 generates a node encoded representation of Node 1 by combining the node ID and the node position information of Node 1, and IDs of the element name, the element content, the attribute name, the attribute value associated with Node 1 which are defined by the XML document. If the element content, the attribute name, and/or the attribute value associated with Node 1 are not defined in the XML document, a null value is assigned to the ID corresponding to the missing entry. Since every node must have an element name, an element name ID is always included in a node encoded representation.

Following the procedure described above, the structured document encoded representation generator 16 generates a node encoded representation of Nodes 2 to 9. The structured document encoded representation generator 16 then combines the node encoded representations associated with Nodes 1 to 9, and further combines data related to the element name table, the element content table, the attribute name table, and the attribute value table to generate a structured document encoded representation.

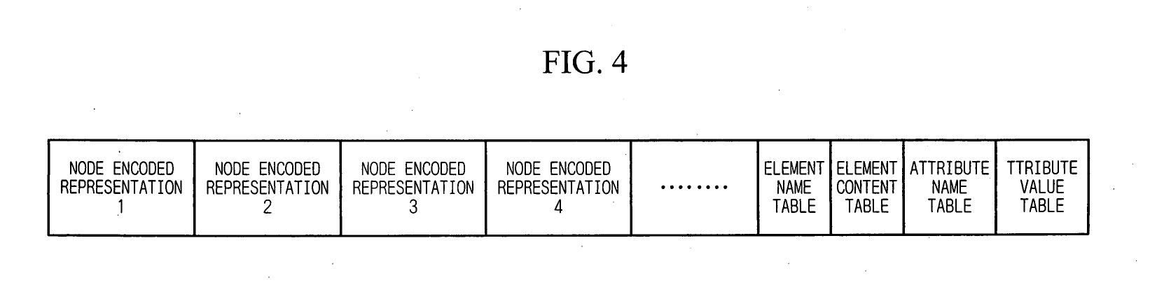

In FIG. 4, data structure of structured document encoded representation according to one embodiment of the present invention is shown. As shown in this figure, the structured document encoded representation shown in FIG. 4 contains node encoded representations corresponding to each node in a structured document (Node Encoded Representations 1, 2, 3, 4, . . . ) and data related to the element name table, the element content table, the attribute name table, and the attribute value table.

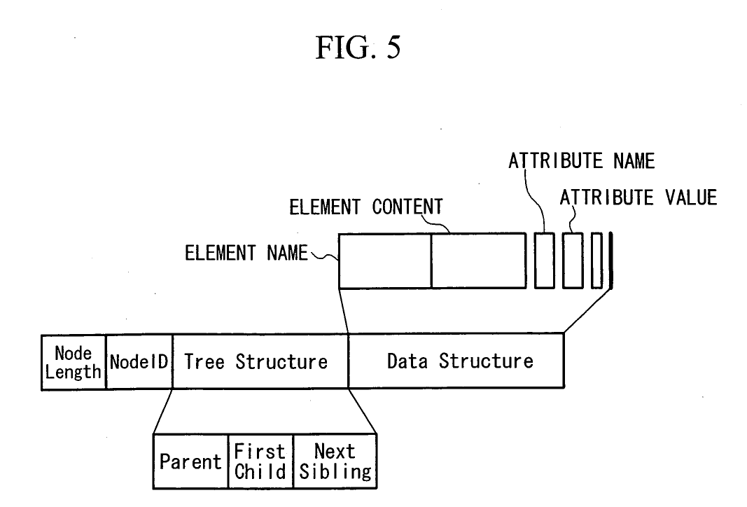

In the structured document encoded representation of this embodiment, while element name IDs, element content IDs, attribute name IDs, and attribute value IDs are stored in the “Data Structure” field in node encoded representations, and actual data associated with these IDs (i.e., element names, element contents, attribute names, and attribute values) are stored in the tables. However, in an alternative embodiment, the data, i.e., element names, element contents, attribute names, and attribute values may be stored in the “Data Structure” field, rather than storing their IDs, and data related to the element name table, the element content table, the attribute name table, and the attribute value table are not stored in a structured document encoded representation. Data structure of a node encoded representation according to this alternative embodiment is shown in FIG. 5.

FIG. 5 illustrates the second example of a structure of a node encoded representation. As shown in FIG. 5, the “Node Length” field is added at the beginning of each node encoded representation because the length of a node encoded representation is variable.

The structured document encoder described above has a computer system incorporated therewithin. The process steps described above are stored in a computer readable medium as a program. The computer reads the program, and executes the process of these steps. The computer readable medium includes, but is not limited to, magnetic disks, magneto-optical disks, CD-ROMs, DVD-ROMs, and semiconductor memories. Alternatively, the computer program may be delivered to computers via a communication line, and a computer which has received the delivered program may execute the program.

In addition, the program described above may execute only a part of the processes descried above. Furthermore, the program may be executed in combination with another program which has been stored in a computer system. Such a program is generally referred to as a difference file (difference program).

As described herein, the encoding format according to the present invention reduces processing steps and processing time required for retrieving a portion of data from a structured document, e.g., an XML document, by eliminating the need for decoding and parsing of the entire document. Furthermore, the encoding format according to the present invention may help reduce the size of encoded structured documents.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

1. A structured document encoder for encoding a structured document which defines a tree structure comprising nodes having node content information, comprising:
a node identifier assigning unit for assigning a node identifier to each of the nodes;
a node position information generator for generating node position information for each of the nodes, node position information of an given node from the nodes comprising at least an identifier of the given node, an identifier of a child node of the given node, and an identifier of a next sibling node which has the same parent node as the given node; and
a structured document encoded representation generator for generating a structured document encoded representation by combining the node position information and the node content information of all of the nodes.

2. The structured document encoder according to claim 1, wherein the node position information further comprises an identifier of a parent node of the given node.

3. The structured document encoder according to claim 1, wherein each of the nodes is associated with an element name, and at least one of an element content, an attribute name, and an attribute value which are described in the structured document, and node content information of the given node comprises an element name, and at least one of an element content, an attribute name, and an attribute value associated with the given node.

4. The structured document encoder according to claim 1, wherein each of the nodes is associated with an element name, and at least one of an element content, an attribute name, and an attribute value which are described in the structured document, and the structured document encoder further comprises:
an element name table generator for assigning an element name identifier to an element name associated with each of the nodes and generating an element name table which defines a relationship between the element name and the element name identifier;
an element content table generator for assigning an element content identifier to an element content associated with each of the nodes and generating an element content table which defines a relationship between the element content and the element content identifier;
an attribute name table generator for assigning an attribute name identifier to an attribute name associated with each of the nodes and generating an attribute name table which defines a relationship between the attribute name and the attribute name identifier; and
an attribute value table generator for assigning an attribute value identifier to an attribute value associated with each of the nodes and generating an attribute value table which defines a relationship between the attribute value and the attribute value identifier, wherein
the node content information of the given node comprises the element name identifier, and at least one of the element content identifier, the attribute name identifier, and the attribute value identifier associated with the given node, and
the structured document encoded representation generator generates a structured document encoded representation by combining the element name table, the element content table, the attribute name table, and the attribute value table, in addition to the node position information and the node content information of all of the nodes.

5. A method for encoding a structured document which defines a tree structure comprising nodes having node content information, comprising the steps of:
assigning a node identifier to each of the nodes based on the tree structure;
generating node position information for each of the nodes, node position information of an given node from the nodes comprising at least an identifier of the given node, an identifier of a child node of the given node, and an identifier of a next sibling node which has the same parent node as the given node; and
generating a structured document encoded representation by combining the node position information and the node content information of all of the nodes.

6. A program for encoding a structured document which defines a tree structure comprising nodes having node content information, comprising processing steps of:
assigning a node identifier to each node based on a tree structure,
generating node position information for each of the nodes, node position information of an given node from the nodes comprising at least an identifier of the given node, an identifier of a child node of the given node, and an identifier of a next sibling node which has the same parent node as the given node; and
generating a structured document encoded representation by combining the node position information and the node content information of all of the nodes.
